(19) United States
(12) Patent Application Publication
(10) Pub. No.: US 2021/0229137 A1
(43) Pub. Date: Jul. 29, 2021

(54) PIPELINE WASHING AND DRYING SYSTEM

(71) Applicant: James Van Voorhis, Mount Vernon, IL (US)

(72) Inventor: James Van Voorhis, Mount Vernon, IL (US)

(21) Appl. No.: 17/052,852

(22) PCT Filed: May 1, 2019
(86) PCT No.: PCT/US2019/030097

§ 371 Date: Nov. 4, 2020

Related U.S. Application Data
(60) Provisional application No. 62/667,117, filed on May 4, 2018.

(51) Int. Cl. B08B 9/023; B08B 5/02; B05C 5/02; F16L 45/00

(52) U.S. Cl. CPC B08B 9/023; B08B 5/02; B08B 2209/02; B05C 5/027; F16L 45/00; B05C 5/0241

(57) ABSTRACT

A pipe washing and drying system includes a ring structure defining a radially inner surface and a radially outer surface, the ring structure having a first portion and a second portion hingedly coupled to the first portion. The ring structure further comprises nozzles and rollers defined in the radially inner surface and extending radially inward. The pipe washing and drying system may further include a tent structure comprising a frame and a protective covering supported thereby. The tent frame is coupled between two of the ring structures such that the protective covering covers a section of the pipe between the two ring structures.

### CROSS-REFERNCE TO RELATED APPLICATION

This application claims the benefit of U.S. Provisional Patent Application Ser. No. 62/667,117, filed May 4, 2018, the entire contents of which are incorporated herein by reference.

### FIELD OF THE DISCLOSURE

The field of the disclosure relates generally to pipeline systems, and, more specifically, to pipeline washing and drying systems.

### BACKGROUND OF THE DISCLOSURE

Welded pipe is coated to provide cathodic protection and increase longevity of the pipe. To insure proper cathodic protection, the coating must be continuous and free of holes or disruptions. To check the quality of the coating on a pipe prior to burial, a jeeping tool (hereinafter referred to as a “jeep”) may be used. The jeep produces an electrical current through a metal coil that is placed around the pipe. If contact is made between the metal coil and the metal surface of the pipe, the jeep emits an alarm, indicating the presence of a flaw in the coating. Flaws are repaired, and the jeep is used on the pipe again. This “jeeping” is repeated until there is no indication of flaws in the pipe coating. Only after a section of pipe has passed a jeep inspection can it be buried per use.

When using a jeep, the section of pipe section to be inspected must be clean and dry. Current methods of washing and drying pipe prior to jeeping rely on manual efforts. For example, drying of wet pipe may be done by hand using propane burners or torches. In addition, because laying and burying pipe is performed outdoors, the ability to inspect pipe using a jeep may depend on weather conditions. For example, a clean, dry section of pipe may get rewetted if it starts to rain. This may lead to delays as crew members may be forced to wait for improved weather conditions before a section of pipe may be inspected. Therefore, a system for efficiently cleaning and drying pipe sections is needed. In addition, the system must enable protecting clean, dry sections of pipe from the elements.

### SUMMARY OF THE DISCLOSURE

In one aspect, a pipe washing and drying system includes a ring structure defining a radially inner surface and a radially outer surface, the ring structure having a first portion and a second portion hingedly coupled to the first portion by a hinge coupled to the radially outer surface. The ring structure further includes a set of nozzles defined in the radially inner surface and extending radially inward from the radially inner surface, wherein the set of nozzles is in fluid communication with a fluid source, and a plurality of rollers attached to the radially inner surface and extending radially inward from the radially inner surface.

In another aspect, a pipe washing and drying system includes two ring structures, each ring structure respectively defining a radially inner surface and a radially outer surface, each ring structure having a first portion and a second portion hingedly coupled to the first portion by a hinge coupled to the radially outer surface. Each ring structure further includes a set of nozzles defined in the radially inner surface and extending radially inward from the radially inner surface, wherein the set of nozzles is in fluid communication with a fluid source. Each ring structure also includes a plurality of rollers attached to the radially inner surface and extending radially inward from the radially inner surface. The pipe washing and drying system further includes a tent structure including a frame coupled to a first of the two ring structure at a first end of the frame and coupled to the second of the two ring structures at an opposing second end of the frame. The tent structure also includes a protective covering supported by the frame and extending from the first end of the frame to the second end of the frame such that a section of the pipe between the two ring structures is covered by the protective covering.

In a further aspect, a method of washing and drying a pipe is provided. The method includes positioning a ring structure circumferentially about the pipe at a first location, the ring structure including a set of nozzles extending radially inward from a radially inner surface thereof and a connector in fluid communication with the set of nozzles. The method also includes coupling the connector to a manifold system of a fluid source such that the connector and the set of nozzles are in fluid communication with the fluid source and fluid from the fluid source is expelled through the set of nozzles onto an exterior surface of the pipe. The method further includes moving the ring structure longitudinally along the pipe from the first location to a second location, such that the exterior surface of the pipe from the first location to the second location is cleaned.

### BRIEF DESCRIPTION OF THE DRAWINGS

FIG. 1 illustrates an example pipe washing and drying system.

FIG. 2 is a side perspective view of an example ring structure for use with the pipe washing and drying system shown in FIG. 1.

FIG. 3 is a side plan view of the ring structure shown in FIG. 2.

FIG. 4 is a side plan view of another example ring structure for use with the pipe washing and drying system shown in FIG. 1.

FIG. 5 is a side plan view of another example ring structure for use with the pipe washing and drying system shown in FIG. 1.

FIGS. 6A and 6B illustrate example embodiments of a tent structure that may be used with the pipe washing and drying system shown in FIG. 1.

FIG. 7 illustrates an alternative embodiment of a tent structure that may be used with the pipe washing and drying system shown in FIG. 1.

FIG. 8 is an example of a scraper for use with the pipe washing and drying system shown in FIG. 1.

FIG. 9 illustrates a first and a second ring structure arranged in series for use with the pipe washing and drying system shown in FIG. 1.

FIGS. 10A and 10B depict a braking assembly that may be used with the pipe washing and drying system shown in FIG. 1.

Corresponding reference characters indicate corresponding parts throughout the drawings.

### DETAILED DESCRIPTION OF THE DISCLOSURE

The present disclosure relates to systems and methods for cleaning and drying sections of pipe or other similar structures (e.g., long cylindrical structures such as beams, poles, etc.). The disclosed systems facilitate the efficient cleaning and drying of pipe sections while protecting pipe surfaces from the environment. Protected pipe sections may therefore be subjected to various treatment or inspection steps, including jeeping, with less concern for environmental factors (e.g., precipitation). Thus, the disclosed systems may be readily incorporated into existing pipeline preparation, treatment, and inspection processes. The disclosed systems may decrease pipeline installation timelines and significantly reduce weather-related delays.

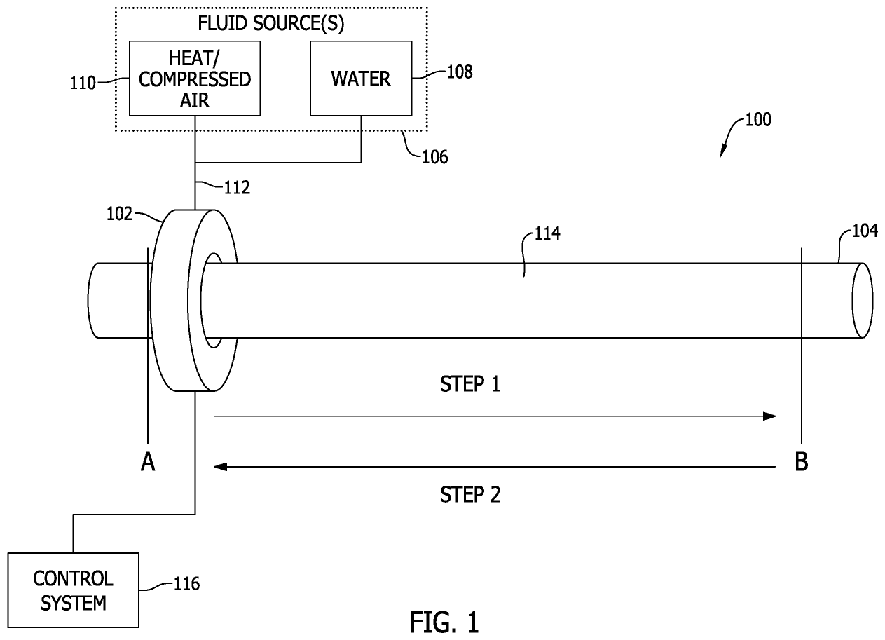

FIG. 1 illustrates an example pipe washing and drying system 100. In the illustrated embodiment, the system 100 includes a ring structure 102 positioned circumferentially about a pipe 104. The ring structure 102 is in fluid communication with one or more fluid sources, generally designated by 106. In the illustrated embodiment, the fluid sources 106 include a water (or other cleaning fluid) source 108 and a compressed air (or other cleaning/drying air or gas) source 110. The compressed air source 110 may alternatively include a heating fluid source (e.g., heated gas and/or liquid, for drying and/or de-icing the pipe 104). Accordingly, the compressed air source 110 may alternatively be referred to as a “heat source” 110. The ring structure 102 is in fluid communication with the water source 108 and/or the heat/compressed air source 110 through a manifold system 112. The manifold system 112 may include valves and/or controls to facilitate switching between fluid sources.

As described further herein, the ring structure 102 includes a plurality of nozzles to eject fluid from one or more fluid sources 106 onto an exterior surface 114 of the pipe 104. This configuration enables the cleaning of continuous sections of the pipe 104. In the illustrated embodiment, the pipe 104 is cleaned and/or dried, for example, between points A and B. Step 1 is a pipe washing step, and step 2 is a pipe drying step. In step 1, the ring structure 102 is initially at point A and is in fluid communication with the water source 108 through the manifold system 112. Water, or any suitable cleaning/washing fluid, is directed toward the pipe surface 114 and causes dirt and debris to be removed from the pipe 108 as the ring structure 102 passes therearound. The ring structure 102 is moved along the length of the pipe 104 from point A to point B.

At step 2, the ring structure 102 is at point B or any other location along the pipe 104. In the illustrated embodiment, step 2 is shown directly subsequent to step 1, such that the ring structure 102 has been used to wash the pipe 104 between point A and B. Fluid communication is established between the ring structure 102 and the compressed air source 110 through the manifold system 112. Air, or any suitable drying fluid, is directed toward the pipe surface 114 and causes moisture to be removed from the pipe 104 as the ring structure 102 passes therearound. The ring structure 102 is rolled along the length of the pipe 104 from point B to point A.

In an alternative embodiment, the ring structure 102 is stationary (e.g., is coupled to a stationary frame, not shown). In such an embodiment, the pipe 104 is moved through the ring structure 102 to be washed and/or dried.

In some embodiments, control of the movement of the ring structure 102 along the pipe 104 (or, alternatively, the pipe 104 through the ring structure 102), and/or control of the ejection of fluid from the ring structure 102, is performed manually. For example, an operator (not shown) may walk or otherwise travel alongside the ring structure 102 and manually move the ring structure 102 along the pipe 104 (or, alternatively, may move the pipe 104 through the ring structure 102), and/or may manually switch between fluid sources 106 to which the ring structure 102 is coupled. Additionally or alternatively, control of the ring structure 102 (or, alternatively, the pipe 104) is performed electronically, automatically, and/or remotely (with respect to the ring structure 102) through a control system 116. For example, the control system 116 may facilitate the movement of the ring structure 102 along the pipe 104 (or, alternatively, movement of the pipe 104 through the ring structure 102) via one or more wired or wireless drive control systems (not shown) or facilitate fluid communication between the ring structure 102 and one or more fluid sources 106.

It should be readily understood that in some embodiments, only step 1 is performed. In other words, the pipe washing and drying system 100 is only used to wash the pipe 104. In other embodiments, only step 2 is performed. In other words, the pipe washing and drying system 100 is only used to dry the pipe 104. In still other embodiments, the fluid (e.g., heated liquid and/or gas) in one or more of the fluid sources 106 is heated to facilitate melting of ice, snow, or other frozen debris during, for example, step 1. Moreover, points A and B are provided for illustrative purposes only and neither the location of points A and B nor the direction of the arrows provided with respect to points A and B are intended to limit the scope of the present disclosure in any way.

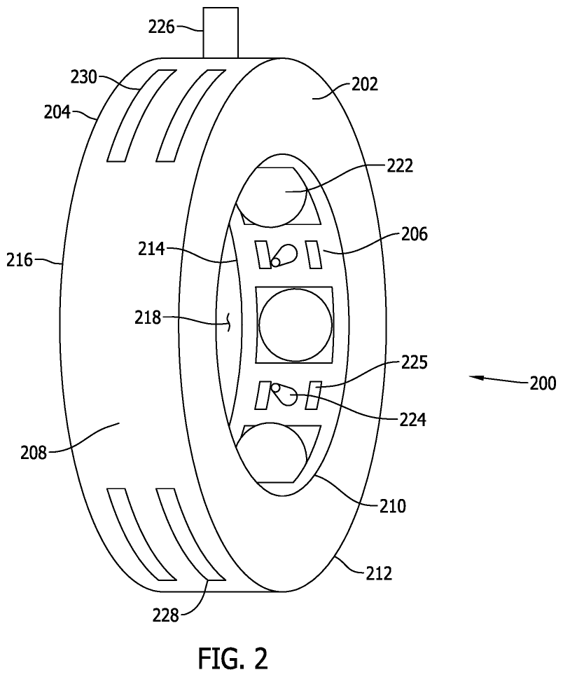

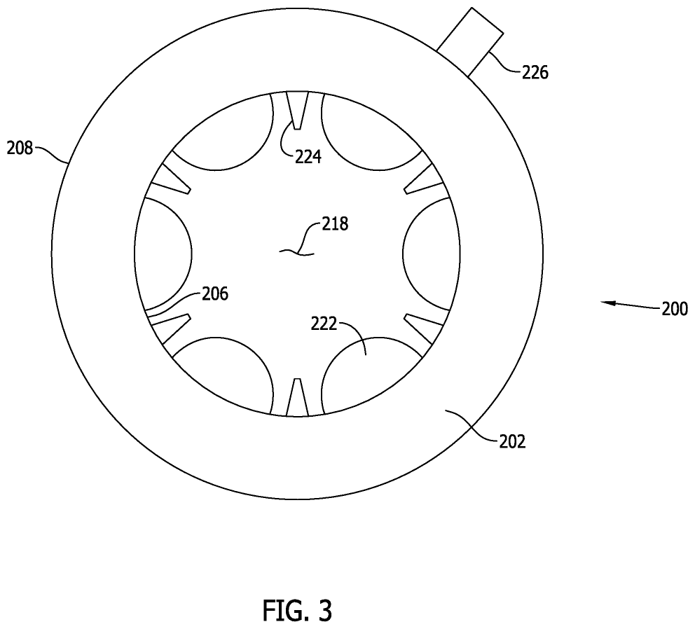

FIG. 2 is a side perspective view of an example ring structure 200 for use with the pipe washing and drying system 100 (shown in FIG. 1). FIG. 3 is a side plan view of the ring structure 200. The ring structure 200 may be substantially similar to the ring structure 102 illustrated in FIG. 1. In the illustrated embodiment, the ring structure 200 includes a front facing surface 202 and a rear facing surface 204 opposite and parallel to the front facing surface 202. The ring structure 200 further includes a radially inner surface 206 and a radially outer surface 208. The front facing surface 202 and the radially inner surface 206 are connected along an edge 210. The front facing surface 202 and the radially outer surface 208 are connected along an edge 212. The rear facing surface 204 and the radially inner surface 206 are connected along an edge 214. The rear facing surface 204 and the radially outer surface 208 are connected along an edge 216. In the example embodiment, the edges 210, 212, 214, and 216 form angles, however, in other embodiments, the edges 210, 212, 214, and 216 are rounded. The surfaces 202, 204, 206 and 208 define a channel 218 through which a pipe (e.g., the pipe 104 illustrated in FIG. 1) or similar structure may extend through the ring structure 200. The channel 218 may have diameter of from about two inches to about 80 inches, to accommodate various diameters of pipes.

According to the illustrated embodiment, a plurality of rollers or wheels 222 are coupled to the ring structure 200 and extend partially into the channel 218. The rollers 222 may be annular, wheel-type structures that rotate around an axis or may be spherical in shape. The rollers 222 are configured to contact an exterior surface of a pipe (e.g., the pipe 104 illustrated in FIG. 1) or other structure extending through the channel 218 of the ring structure 200. The rollers 222 facilitate movement of the ring structure 200 along the pipe or other structure. The illustrated ring structure 200 includes six spherically shaped rollers 222. Other embodiments include fewer or more than six rollers.

In the example embodiment, the ring structure 200 further includes a set of nozzles 224 through which fluid from a fluid source (e.g., one of the fluid sources 106 illustrated in FIG. 1) is expelled from the ring structure 200 into the channel 218 (i.e., onto a pipe or other structure extending therethrough). A connector 226 is coupled to the radially outer surface 208 and is configured to attach to the manifold structure 112 (shown in FIG. 1) to fluidly couple the ring structure 200 to the fluid source 106. The connector 226 is in fluid communication with an interior (not shown) of the ring structure 200 and to the nozzles 224. Accordingly, when the connector 226 is coupled to the manifold structure 112 or otherwise is in fluid communication with the fluid source 106, the set of nozzles 224 likewise are in fluid communication with the fluid source. The nozzles 224 spray the fluid radially inwardly. In the illustrated embodiment, the ring structure 200 includes openings 228 (“lower openings” 228) through which fluid may drain from the channel 218 through the ring structure 200, to avoid build-up of debris and/or cleaning fluid on the radially inner surface 206. In addition, the ring structure includes openings 230 (“upper openings”) through which gasses and/or lighter debris may escape from the channel 218 through the ring structure 200 as the pipe 104 is cleaned and/or dried.

In the example embodiment, the ring structure 200 includes six nozzles 224. In other embodiments, the ring structure 200 includes more or fewer than six nozzles. In some alternative embodiments, the nozzles 224 are arranged on another surface of the ring structure 300, such as front facing surface 202 or the rear facing surface 204. In some embodiments, the ring structure 200 includes more than one set of nozzles 224. For example, the ring structure 200 may include a first set of nozzles 224 (which are embodied as cone-type nozzles in FIG. 2) for directing water or other cleaning fluid into channel 218 for cleaning purposes and a second set of nozzles 225 (which are embodied as vent-type nozzles in FIG. 2) for directing compressed air into channel 218 for drying purposes. In such embodiments, the ring structure 200 may include more than one connector 226. For example, the ring structure 200 may include a first connector to connect the first set of nozzles with a source of water or other cleaning fluid and a second connector to connect the second set of nozzles with a source of compressed air. In other embodiments, the one or more connectors are attached to any of surfaces 202, 204, 206, 208 of the ring structure 200.

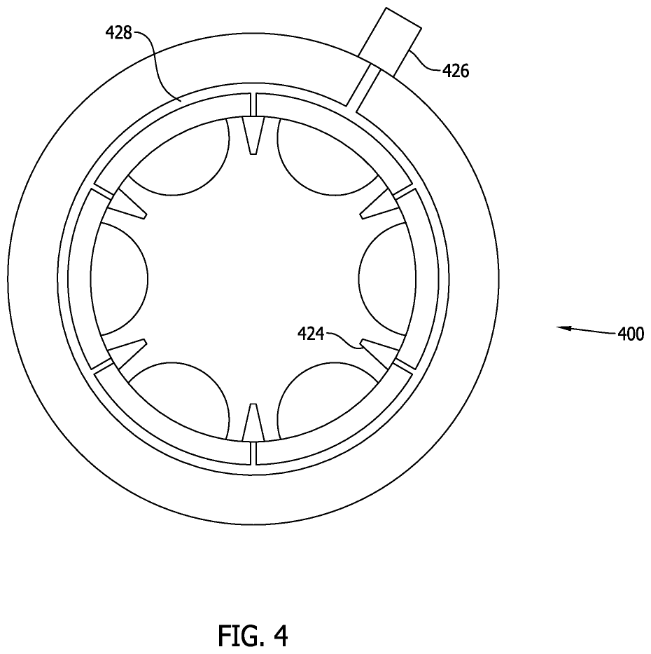

FIG. 4 illustrates another embodiment of a ring structure 400 for use with the pipe washing and drying system 100 (shown in FIG. 1). The ring structure 400 may be substantially similar to the rings structure 200 (shown in FIGS. 2 and 3). However, in the illustrated embodiment, the ring structure 400 includes a connector 426 fluidly coupled with an external piping system 428. Accordingly, rather than being in fluid communication with an interior of the ring structure 400, the connector 426 fluidly couples a set of nozzles 424 to a fluid source (e.g., a fluid source 106, shown in FIG. 1) via the external piping system 428. Having an external piping system 428 (as opposed to an internal piping system coupling the connector to the nozzles) may facilitate more convenient, easier, and/or more cost-effective maintenance and/or repair of the ring structure 400.

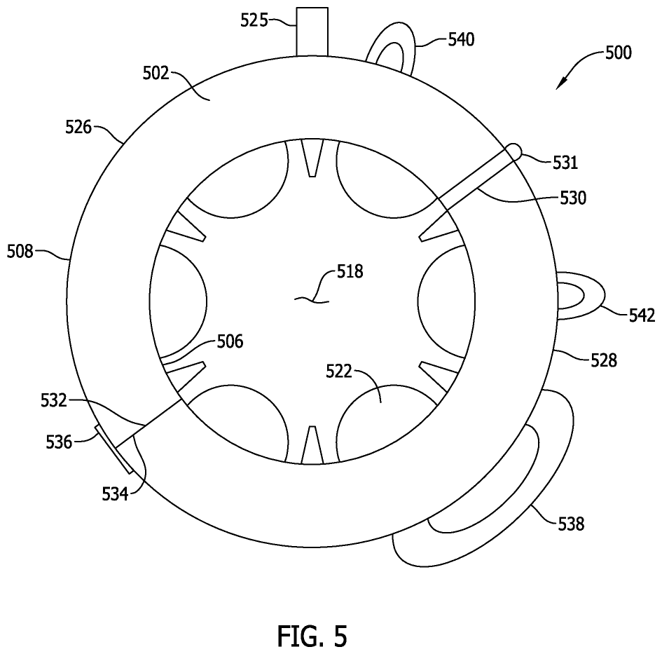

FIG. 5 is a side plan view of an example ring structure 500 for use with the example pipe washing and drying system 100 (shown in FIG. 1). Similar to the ring structure 200 (shown in FIGS. 2 and 3), the ring structure 500 includes a front facing surface 502, a rear facing surface (not specifically shown) opposite the front facing surface 502, a radially inner surface 506, a radially outer surface 508, a channel 518, rollers 522, nozzles 524, and a connector 525. The ring structure 500 is embodied as a two-part structure including a first (semi-circular) piece 526 and a second (semi-circular) piece 528. The semi-circular pieces 526 and 528 are connected by a hinge 530 that enables the semi-circular pieces 526 and 528 to rotate around an axis 531 defined by the hinge 530. The semi-circular pieces 526 and 528 separate along respective free edges 532 and 534 thereof, which are arranged opposite the hinge 530. Thus, the ring structure 500 may be opened, placed circumferentially around a pipe or other structure, and closed, by rotating the pieces 526 and 528 about the hinge 530. In the example embodiment, the ring structure 500 is secured in a closed position by a clasp 536.

The ring structure 500 further includes a handle 538 that facilitates manual movement of the ring structure 500 longitudinally along a length of pipe or other structure extending through the channel 518. The ring structure 500 further includes a first connection component 540 and a second connection component 542. The connection components 540 and 542 enable connection to machinery (e.g., a crane) that may assist in properly placing and/or orienting the ring structure 500 about a structure to be treated by the ring structure 500 (e.g., the pipe 104 shown in FIG. 1). As described below, the connection components 540 and 542 may further enable connection of the ring structure 500 to a tent structure that may be used to protect clean and/or dry sections of pipe from the elements.

It should be readily understood that any feature of any of the ring structures 200, 400, and/or 500 described herein may be used in any combination without departing from the scope of the present disclosure.

Because the pipe cleaning and drying process illustrated in FIG. 1 may be performed outdoors, it is desirable to protect a section of pipe from the elements, for example, during a jeeping process implemented prior to, simultaneous with, or after a heating/cleaning/drying process. As further described herein, the jeeping process and any heating/cleaning/drying process may be implemented iteratively until a desired outcome is achieved.

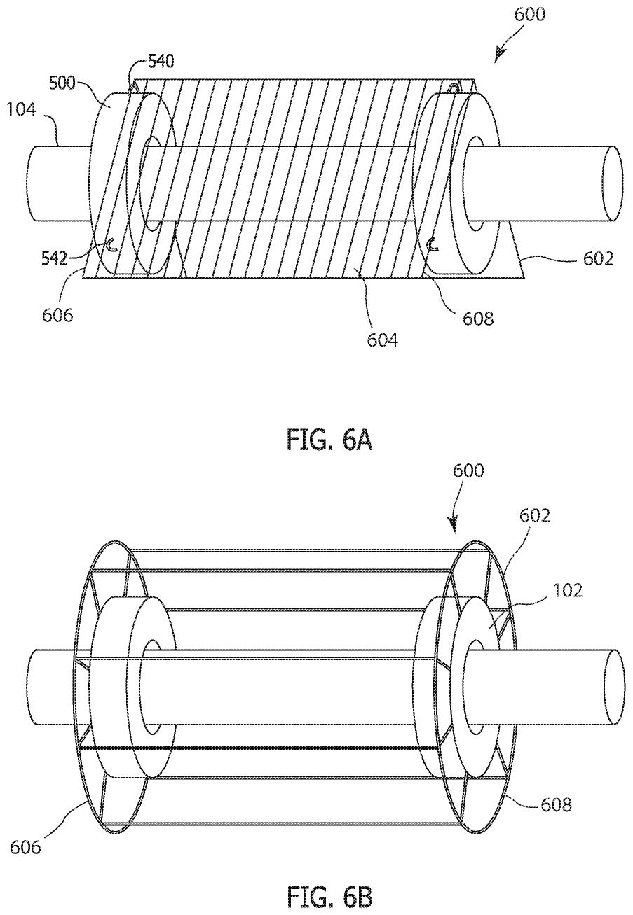

FIGS. 6A and 6B illustrate embodiments of a tent structure 600 that may be used with the pipe washing and drying system 100 (shown in FIG. 1). The tent structure 600 is configured to cover a section of the pipe 104 (shown in FIG. 1) from an environment therearound. For example, the tent structure 600 protects sections of the pipe 104 from the environment from getting dirtied or wet during a jeeping process.

In the illustrated embodiments of FIG. 6A, the tent structure 600 includes a frame 602 coupled between two ring structures (e.g., two ring structures 500, shown in FIG. 5). The frame 602 supports a protective covering 604 that spans from a first end 606 of the frame 602 to a second end 608 of the frame 602. The protective covering 604 may comprise any suitable flexible, foldable, and/or elastic material, including fabric, plastic or polymeric material, metal, and/or combinations thereof. Although the frame 602 is illustrated as defining a generally triangularly shaped tent structure 600, it should be readily understood that the frame 602 (and, therefore, the tent structure 600) is arched, square, hexagonal, and/or otherwise shaped, in alternative embodiments.

Although not specifically shown in the embodiment of FIG. 6A, the frame 602 may include one or more coupling components (e.g., hooks, straps, other fasteners, etc.) that couple the frame 602 to the ring structures 500. More particularly, the coupling components connect the tent structure 600 to the ring structures 500 at the respective connection components 540 and 542 located on the ring structures 500.

Turning to FIG. 6B, the illustrated tent structure 600 is embodied as with substantially cylindrical or rounded frame 602 extending from the first end 606 to the second end 608 thereof. The frame 602 is coupled to two ring structures (e.g., two ring structures 102, shown in FIG. 1). In the illustrated embodiment, the frame 602 is coupled to an end surface of each ring structure 102 (one of the front facing surface 202 and the rear facing surface 204 of each ring structure 102, as shown in FIG. 2) and/or to an edge thereof.

In the example embodiments of FIGS. 6A and 6B, the tent structure 600 is sized to provide protection to a pipe and one or more people therebelow, such that work on the pipe may be performed under the protective covering 604. In addition, in some embodiments, the tent structure 600 includes one or more wheels, rollers, or other such components to facilitate moving the tent structure 600 along the pipe 104. In an alternative embodiment, the tent structure 600 is stationary or fixed, and the pipe 104 is moveable through the tent structure 600.

Use of the tent structure 600 as illustrated in either of FIGS. 6A and 6B enables jeeping of the pipe 104 during inclement weather, such as rain or snow. One or more washing, drying, and/or heating processes may be implemented using the ring structure(s) 500 before, during, and/or after the jeeping process. The jeeping is performed on the clean, dry pipe to verify the pipe 104 is properly coated. If the jeeping process identifies issues with the coating of the pipe 104, repairs can be made under the tent structure 600, where the pipe 104 is maintained in a clean, dry state. The jeeping and repair process is repeated as many times as necessary along the length of the pipe 104. Once a particular section is verified to be properly and completely coated, the tent structure 600 and ring structure 500 are translated along the pipe 104 to a subsequent section, for the above-described sequence of process(es) to be repeated (or, alternatively, the pipe 104 is translated through the tent structure 600).

In some embodiments, the tent structure 600 includes or is operatively coupled to one or more jeeping devices (not shown), such that the tent structure 600 and the jeeping device are simultaneously deployed in a single system.

Moreover, in some embodiments, the tent structure 600 is coupled to other than two ring structures. For instance, one or more additional ring structures may be used to support the tent structure. Such ring structures may not include nozzles or vents but may instead be used as supplemental frame components for supporting the tent structure 600 and improving stability of the tent structure 600 during translation thereof along the pipe. In addition, the tent structure 600 and/or the supplementary ring structure(s) may be removable or detachable from the pipe and/or the ring structures 500. In other words, the tent structure 600 is attachable to and detachable from the ring structures 500 according to the need therefor. It should be readily understood, therefore, that the ring structures 500 (and/or any other ring structures described herein) are useable with and/or without any tent structure coupled thereto.

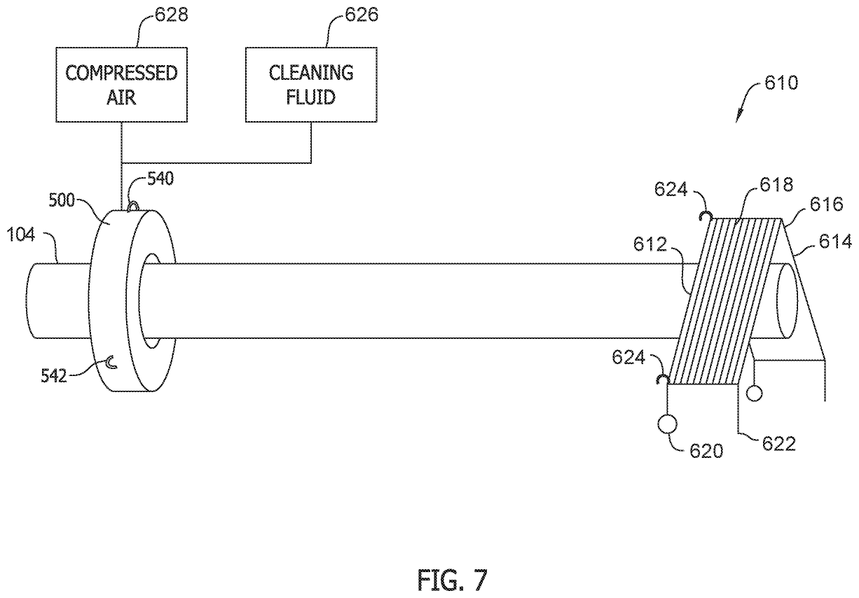

FIG. 7 illustrates an alternative embodiment of a tent structure 610 that may be used with the pipe washing and drying system 100 (shown in FIG. 1). The tent structure 610 is configured to cover a section of the pipe 104 (shown in FIG. 1) from an environment therearound. For example, the tent structure 610 protects sections of the pipe 104 from the environment from getting dirtied or wet during a jeeping process.

In the illustrated embodiment, the tent structure 610 defines includes a mobile side 612 and a stationary side 614 thereof. The tent structure 610 includes a frame 616 supporting a protective covering 618. The protective covering 618 extends from the mobile side 612 to the stationary side 614 of the tent structure 610. In the illustrated embodiment, the protective covering 618 is embodied as an accordion-style awning.

Connected to the mobile side 612 of the tent structure 610 are wheels 620 that facilitate movement of the mobile side 612 along a surface (e.g., the ground). Connected to the stationary side 614 are stabilizing structures 622 configured to immobilize the stationary side 614 relative to the ground. The stabilizing structures 622 may include stakes, weights, anchors, and/or any other suitable structure. The tent structure 610 further includes coupling components 624 configured to connect the tent structure 610 to a ring structure (e.g., the ring structure 500, shown in FIG. 5). The coupling components 624 are embodied as hooks that couple the tent structure 610 to the ring structure 500 at connection components 540 and 542 located on the ring structure 500.

The tent structure 610 may be used in the cleaning, drying, and jeeping process(es) described above with respect to FIGS. 6A and 6B. In one embodiment, the ring structure 500 is initially at a first point (e.g., point A, shown in FIG. 1) and in fluid communication with a cleaning fluid source 626 (e.g., air or other gas, water or other liquid, etc., which may be heated). The ring structure 500 is then rolled along the length of the pipe 104 to wash the pipe 104 before the jeeping process. The tent structure 6610 is then coupled to the ring structure 500. In the illustrated embodiment, the coupling components 624 are coupled to the connection components 540, 542. After the ring structure 500 is coupled to the tent structure 610, the ring structure 500 is translated in the opposite direction along the length of the pipe 104.

Subsequently, fluid communication is established between the ring structure 500 and a drying fluid source 628 (e.g., heated or unheated air). Connection to the ring structure 500 causes the mobile side 612 of the tent structure 610 to move simultaneously with the ring structure 500. The movement of the mobile side 612 of the tent structure 610 in turn causes to the covering 618 to expand over the pipe 104 as the pipe 104 is being dried. Clean, dry sections of the pipe 104 are thus protected from the environment and, in particular, from precipitation. The sequence of jeeping and repair processes, as described above, may then be completed beneath the tent structure 610.

Moreover, it should be readily understood that, in any of the embodiments of the tent structures provided herein, additional and/or alternative process(es) may be performed under the tent structure. For example, the tent structure can be implemented to facilitate coating, welding, X-Ray, and/or any other tasks associated with the pipe thereunder, specifically during inclement weather. Accordingly, while the embodiments provided herein are described with respect to jeeping, the tent structures may be used for any other pipeline work activities.

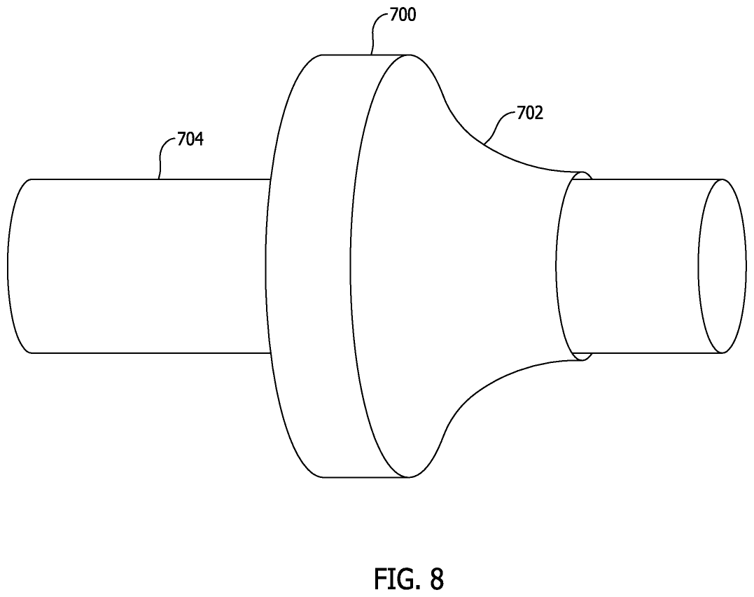

FIG. 8 illustrates a scraper 702 that may be used with the pipe washing and drying system 100 (shown in FIG. 1). The scraper 702 is attached to a ring structure 700. The ring structure 700 may be substantially similar to any of the ring structure 102, 200, 400, and/or 500 (shown in FIGS. 1, 2, 4, and 5, respectively). The scraper 702 may be used to remove large debris or snow from a pipe 704 prior to the pipe 704 getting washed or dried according to the steps illustrated in FIG. 1. The scraper 702 may be attached to a front and/or a back side of the ring structure 700.

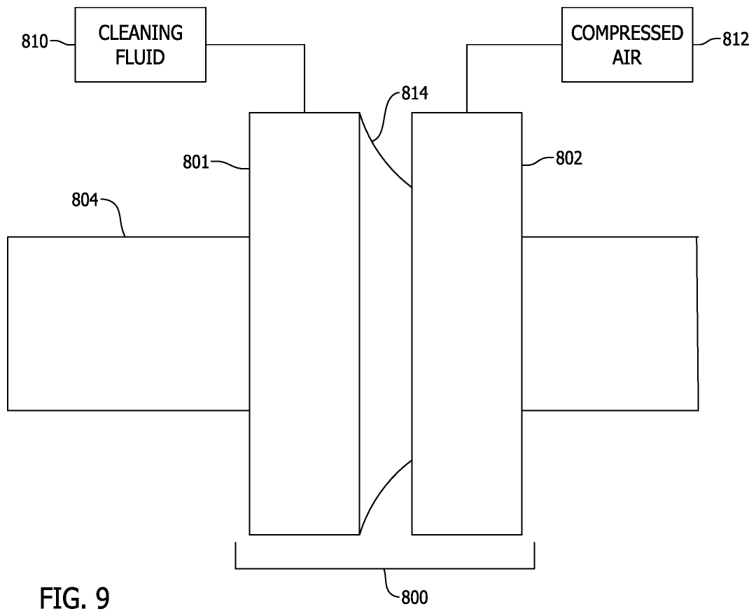

FIG. 9 illustrates a ring structure assembly 800 including a first ring structure 801 and a second ring structure 802 arranged in series. The ring structures 801 and 802 may be substantially similar to any of the ring structure 102, 200, 400, and/or 500 (shown in FIGS. 1, 2, 4, and 5, respectively). In the illustrated embodiment, the first ring structure 801 is fluidly coupled to a water source 810 and the second ring structure 802 is fluidly coupled to a compressed air source 812. Accordingly, use of the ring structure assembly 800 facilitates substantially simultaneous washing and drying of a pipe 804 in a single step.

In the illustrated embodiment, the ring structures 801 and 802 are separated by a shield 814. The shield 814 prevents water being expelled from the first ring structure 801 during cleaning of the pipe 804 from wetting portions of the pipe 804 dried by the second ring structure 802.

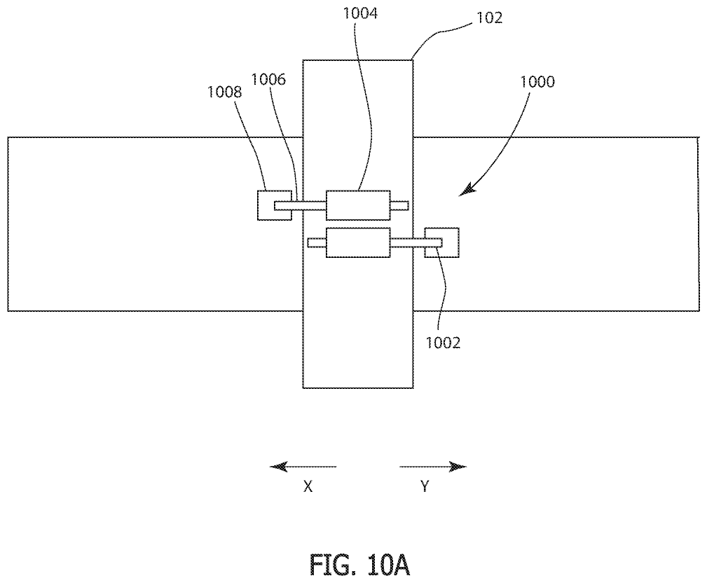

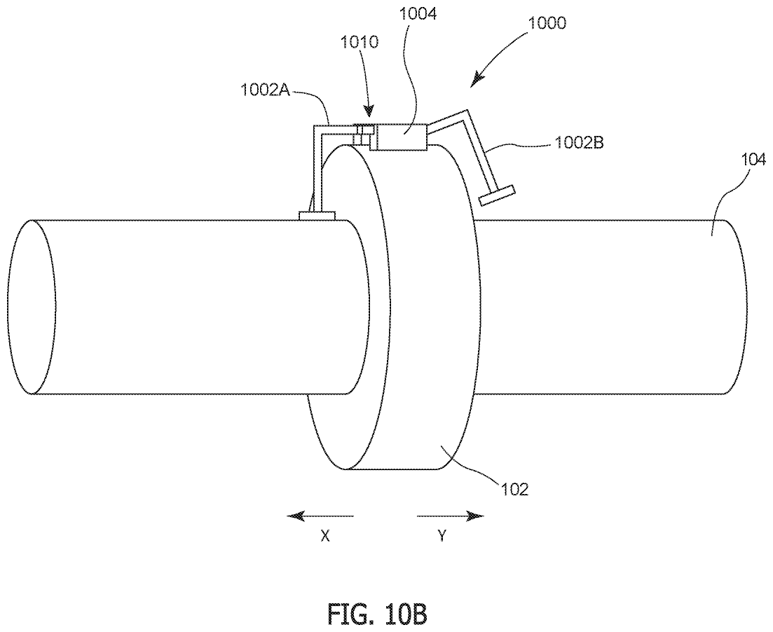

FIGS. 10A and 10B illustrate, respectively, a top view and a side perspective view of a brake assembly 1000 that may be used with the pipe washing and drying system 100 (shown in FIG. 1). The brake assembly 1000 is coupled to a ring structure (e.g., the ring structure 102, also shown in FIG. 1). More particularly, the brake assembly 1000 is coupled to the radially outer surface 208 (shown in FIG. 2) of the ring structure 102.

The brake assembly 1000 includes, in the illustrated embodiment, two brakes 1002, each brake 1002 pivotally or hingedly coupled to a brake mount 1004. Each brake 1002 includes a respective arm 1006 extending from the brake mount 1004 to a foot 1008. Each arm 1006 is pivotally or hingedly coupled to the brake mount 1004 via a respective hinge 1010. Although each arm 1006 is illustrated as coupled to a respective, separate brake mount 1004, it should be readily understood that both arms 1006 may be coupled to the same brake mount 1004, via separate hinges 1010. In the example embodiment, each foot 1008 includes a pad comprised of rubber, plastic, or any other suitable material.

One brake 1002 (a “first brake” 1002A, as shown in FIG. 10B) is oriented in a first direction X, and the other brake 1002 (a “second brake” 1002B, as shown in FIG. 10B) is oriented in a second direction Y opposite the first direction X. In the embodiment of FIG. 10B, the first brake 1002A is in a lowered position, or is “activated.” The second brake 1002B is in a raised position, or is “deactivated.” When either brake 1002 is activated or lowered, the respective foot 1008 engages a surface of the pipe 104 to prevent the ring structure 102 from moving in that direction. The brakes 1002 are independently controllable such that either, both, or neither brakes 1002 may be activated/lowered or deactivated/raised at any time. In some embodiments, the control system 116 (shown in FIG. 1) is operative coupled to the brakes 1002 such that an operator may use the control system 116 to activate and/or deactivate either or both brakes 1002. In other embodiments, the brakes 1002 are manually lowered and raised to activate and deactivate, respectively, the braking function thereof.

The brake assembly 1000 may be implemented with any of the ring structures described herein to provide braking functions such that the ring structures may be used on inclined or sloped terrain. Using the brakes 1002, the ring structures are prevented from undesired movement in either direction.

Example embodiments of pipe cleaning and drying systems are described above in detail. The pipe cleaning and drying systems are not limited to the specific embodiments described herein, but rather, components of the pipe cleaning and drying systems may be used independently and separately from other components described herein. For example, the pipe cleaning and drying systems described herein may be used with a variety of structures, including and without limitation, pipes of varying length and diameter, and ducts of varying length and diameter.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A pipe washing and drying system comprising:
a ring structure defining a radially inner surface and a radially outer surface, the ring structure having a first portion and a second portion hingedly coupled to the first portion by a hinge coupled to the radially outer surface,
wherein the ring structure further comprises:
a set of nozzles defined in the radially inner surface and extending radially inward from the radially inner surface, wherein the set of nozzles is in fluid communication with a fluid source; and
a plurality of rollers attached to the radially inner surface and extending radially inward from the radially inner surface.

2. The pipe washing and drying system of claim 1, wherein the ring structure further comprises a scraper to remove debris from an external surface of a structure extending axially through the ring structure.

3. The pipe washing and drying system of claim 1, wherein the ring structure comprises a first ring structure, the set of nozzles comprise a first set of nozzles, and the fluid source includes a first fluid source, the pipe washing and drying system further comprising a second ring structure arranged in series with the first ring structure, the second ring structure comprising:
a second set of nozzles defined in a radially inner surface of the second ring structure and extending radially inward from the radially inner surface of the second ring structure, wherein the second set of nozzles is in fluid communication with a second fluid source, the second fluid source different from the first fluid source.

4. The pipe washing and drying system of claim 3, wherein the first ring structure and the second ring structure are separated by a shield coupled to at least one of the first ring structure and the second ring structure.

5. The pipe washing and drying system of claim 3, wherein the first fluid source includes a liquid and the second fluid source includes a gas.

6. The pipe washing and drying system of claim 1, wherein the ring structure defines one or more openings extending through the radially inner surface and the radially outer surface, the openings configured to enable draining of fluid through the ring structure.

7. The pipe washing and drying system of claim 1, wherein the ring structure further comprises a handle that facilitates manual movement of the ring structure longitudinally along a structure extending axially through the ring structure.

8. The pipe washing and drying system of claim 1, further comprising a control system configured to electronically control one or more operations of the ring structure.

9. The pipe washing and drying system of claim 1, wherein the ring structure further comprises:
an external piping system; and
a connector that fluidly couples the set of nozzles to the fluid source through the external piping system.

10. A pipe washing and drying system comprising:
two ring structures, each ring structure respectively defining a radially inner surface and a radially outer surface, each ring structure having a first portion and a second portion hingedly coupled to the first portion by a hinge coupled to the radially outer surface,
wherein each ring structure further comprises:
a set of nozzles defined in the radially inner surface and extending radially inward from the radially inner surface, wherein the set of nozzles is in fluid communication with a fluid source; and
a plurality of rollers attached to the radially inner surface and extending radially inward from the radially inner surface; and
a tent structure comprising:
a frame coupled to a first of the two ring structure at a first end of the frame and coupled to the second of the two ring structures at an opposing second end of the frame; and
a protective covering supported by the frame and extending from the first end of the frame to the second end of the frame such that a section of the pipe between the two ring structures is covered by the protective covering.

11. The pipe washing and drying system of claim 10, wherein the tent structure further comprises one or more connector components configured to couple the frame to the two ring structures.

12. The pipe washing and drying system of claim 11, wherein one or more connector components comprise hook components.

13. The pipe washing and drying system of claim 12, wherein each ring structure further comprises one or more respective connection components, the hook components of the tent structure configured to engage the connection components of the two ring structures to couple the tent structure to the two ring structures.

14. The pipe washing and drying system of claim 10, wherein each ring structure further comprises a scraper to remove debris from an external surface of a structure extending axially through the ring structure.

15. The pipe washing and drying system of claim 10, wherein at least one of the two ring structures further comprises a brake assembly coupled thereto, the brake assembly configured to engage a surface of the pipe to prevent movement of the at least one of the two ring structures.

16. A method of washing and drying a pipe comprising:
positioning a ring structure circumferentially about the pipe at a first location, the ring structure including a set of nozzles extending radially inward from a radially inner surface thereof and a connector in fluid communication with the set of nozzles;
coupling the connector to a manifold system of a fluid source such that the connector and the set of nozzles are in fluid communication with the fluid source and fluid from the fluid source is expelled through the set of nozzles onto an exterior surface of the pipe; and
moving the ring structure longitudinally along the pipe from the first location to a second location, such that the exterior surface of the pipe from the first location to the second location is cleaned.

17. The method of claim 16, wherein the fluid source includes a first fluid source including a liquid, the method further comprising:
coupling the connector to a manifold system of a second fluid source, the second fluid source including a gas, such that the connector and the set of nozzles are in fluid communication with the second fluid source and fluid from the second fluid source is expelled through the set of nozzles onto the exterior surface of the pipe; and
moving the ring structure longitudinally along the pipe from the second location to a third location, such that the exterior surface of the pipe from the second location to the third location is dried.

18. The method of claim 16, wherein moving the ring structure comprises electronically controlling movement of the ring structure along the pipe using a control system.

19. The method of claim 16, further comprising coupling a scraper to the ring structure such that, upon moving the ring structure along the pipe, the scraper scrapes debris from the exterior surface of the pipe.

20. The method of claim 16, further comprising heating fluid in the fluid source such that, upon moving the ring structure along the pipe, the heated fluid melts ice from the exterior surface of the pipe.
